(19) United States
(12) Patent Application Publication
(10) Pub. No.: US 2010/0270107 A1
(43) Pub. Date: Oct. 28, 2010

(54) Manually-Releasable Fall Arrest Device

(76) Inventor: Chris Ruis, Jefferson, GA (US)

Correspondence Address: Hill, Kertscher & Wharton, LLP, 3350 Riverwood Parkway, Suite 800, Atlanta, GA, 30339, US

(21) Appl. No.: 12/430,395

(22) Filed: Apr. 27, 2009

(51) Int. Cl. A62B 1/10

(52) U.S. Cl. 182/235

(57) ABSTRACT

A manually-releasable apparatus for arresting a hunter's fall from a tree stand is described herein. The apparatus comprises a satchel with two compartments, one compartment containing a controlled descent device and the other compartment containing a reel upon which a safety strap is wound. The safety strap is attached to the tree and passes through the controlled descent device and then is wound onto the reel. The hunter's safety harness is attached by means of a tether to an eye in the controlled descent device, which is attached to a safety belt secured to a tree. The apparatus quickly arrests a hunter's fall and then allows the hunter to manually release the braking mechanism within the controlled descent device once the hunter has freed himself from obstructions and is in a position to descend to the ground.

### CROSS REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

It is often advantageous while hunting with a bow or rifle in wooded areas to sit in an elevated position. Tree stands in a variety of designs are used for this purpose. The devices are lightweight and compact and consist of a support structure affixed to the trunk of a tree and a seat for the hunter. They allow a hunter to sit high in a tree for long periods of time while hunting. Because many hunters spend long periods of time in the tree stand, it is not uncommon for them to doze off while they are suspended high above the ground. Also, a hunter's attention may be so focused when aiming for a shot that he falls from the relatively small seat. The dangers of falling while perched in a tree stand are manifest.

To address this safety issue, hunters typically wear a safety harness that is attached to some form of fall arresting device. Many of these fall arresting devices use some form of inertia reel assembly, which lock the safety line or belt when a fall occurs. Although these devices save the hunter from a fall, they create their own problems, chief among which is suspension trauma.

Suspension trauma, also known as orthostatic intolerance, occurs when blood pools in the legs and lower extremities. It results from being suspended or confined in an upright position without the ability to move. Such conditions occur when standing at attention for long periods of time without being able to lie down, or being suspended in a harness. Under normal conditions, the leg muscles when walking or moving assist the heart muscle in pumping blood from the lower extremities. However, when the body is upright while suspended in other situations where the legs are unable to provide this assistance, the heart is unable to pump blood from the lower extremities.

Suspension trauma deprives the brain of blood and therefore can, in extreme cases, be fatal. Typically, a person experiencing suspension trauma will go into shock initially, then faint. Under normal circumstances, when a person faints, they fall in a horizontal position, which allows blood to flow back into the brain. However, if a person is suspended upright or confined in an upright position without the ability to move, blood flow to the brain does not occur. As a result, if the situation is not corrected, an upright suspension condition can be fatal.

Suspension trauma typically occurs when a fall arresting device saves a hunter from a fall, but leaves a hunter, literally, dangling. The problem with prior art fall arresting devices is that the inertia reel can only be unlocked when the tension on the belt or cable is released. For a hunter dangling from a safety line, this tension is usually difficult, if not impossible, to release because the fall arrest system is located out of reach of the fallen person. In many cases, a hunter will have fallen in an awkward position that is difficult to get out of. Moreover, the hunter may be hung up or even impaled in some fashion on a tree branch or other protrusion. If a hunter is alone in the wilderness without a means of releasing the suspension and controllably lowering himself to the ground, he faces death or serious injury from suspension trauma, exposure, or from injuries suffered during the fall.

What is therefore needed is a fall arresting device with a locking mechanism that allows a hunter to controllably lower themselves to the ground.

There are a number of fall arresting devices on the market and in use today. For example, the Escape-Rite® is a fall arresting device for use by firemen, linemen, and other workers who work at heights. Petzl® makes a number of rope grab devices for climbers that will arrest vertical falls.

However, these devices do not take account of the conditions faced by hunters who have fallen from a treestand, namely, the presence of obstructions upon which a hunter may become entangled or even impaled. What is needed is a device that will quickly arrest the fall of a person that can be also manually-released to allow a hunter who has fallen out of a tree stand to lower himself to the ground. U.S. Patent Application Publication US20060113147A1 to Harris describes a fall protection system that allows a controlled descent; however, the mechanism used to accomplish the descent is more complex than the apparatus described herein.

### BRIEF SUMMARY OF THE INVENTION

The apparatus described herein allows a hunter who has fallen from a tree stand to lower himself to the ground in a completely controlled fashion. A controlled descent device and a reel for a safety strap are contained in a satchel. One free end of the safety strap is anchored to a tree, the safety strap then passes through the controlled descent device and the excess length of the safety strap is wound onto the reel. The hunter connects his safety harness to an eye in the baseplate of the controlled descent device that protrudes from the bottom of the satchel. The satchel itself is usually suspended 2-3 feet above the hunter's head, so a suspension release strap attached to the hunter's harness is used to release the braking mechanism of the controlled descent device after a fall.

The controlled descent device allows a hunter to controllably lower himself to the ground. The controlled descent device contains a spring-tensioned cam brake. Spring tension keeps the cam brake's braking surface engaged with the safety strap, preventing free travel of the safety strap through the device, thereby arresting a hunter's fall. Prior art cam buckles operate on a similar principle; however, these buckles require a user to release the cam by pressing directly on the lever of the cam. However, because the apparatus described herein is usually attached to a tree at least 2 feet above the hunter's head, directly releasing the cam buckle when a hunter has fallen is nearly impossible. The addition of two rollers within the controlled descent device permits the safety strap to double back over the cam brake lever and apply pressure to the cam brake lever when the hunter pulls on the non-tensioned portion of the safety strap. Thus, a hunter who has fallen and is suspended by the safety strap releases the cam brake by simply pulling on the non-tensioned portion of the safety strap, without actually having to touch the cam brake itself. Releasing the cam brake allows the safety strap to travel freely through the controlled descent device. Because one end of the safety strap is attached to the tree, releasing the cam buckle causes the controlled descent device to trolley along the safety strap, thereby allowing the apparatus and hunter to descend in a controlled fashion to the ground.

The relatively simple structure of the apparatus allows it to be lightweight, easy to replace, and inexpensive, unlike prior art fall arresting devices.

Although hunters are the preferred embodiment's primary user, it will be obvious that the apparatus described herein is suited for use by any person working at heights where falling is a risk.

### BRIEF DESCRIPTION OF THE DRAWINGS

The present invention will be more fully understood from the detailed description given below and from the accompanying drawing of the invention, which however, should not be taken to limit the invention to the specific embodiments enumerated, but are for explanation and for better understanding only. Furthermore, the drawings are not necessarily to scale, emphasis instead being placed upon clearly illustrating the principles of the invention. Finally, like reference numerals in the figures designate corresponding parts throughout the several drawings.

FIG. 1 shows side (FIG. 1-1), front (FIG. 1-2), and top (FIG. 1-3) cutaway views of the satchel, showing the reel and the controlled descent device.

FIG. 2 shows bottom (FIG. 2-1) and top (FIG. 2-2) exterior views of the satchel.

FIG. 3 shows side and front views of the reel.

FIG. 4 is a perspective view of the controlled descent device with the cover installed, showing the baseplate and safety strap.

FIG. 5 is a side view of the controlled descent device with the cover, baseplate, and other components removed for clarity, showing the key internal components of the controlled descent device.

FIG. 6 shows the internal components of the controlled descent device from the opposite side of FIG. 5.

FIG. 7 shows the entire apparatus in use, including satchel, controlled descent device, reel, and safety belt.

FIG. 8 shows a detailed view of a typical satchel and safety strap configuration.

### DETAILED DESCRIPTION OF THE INVENTION

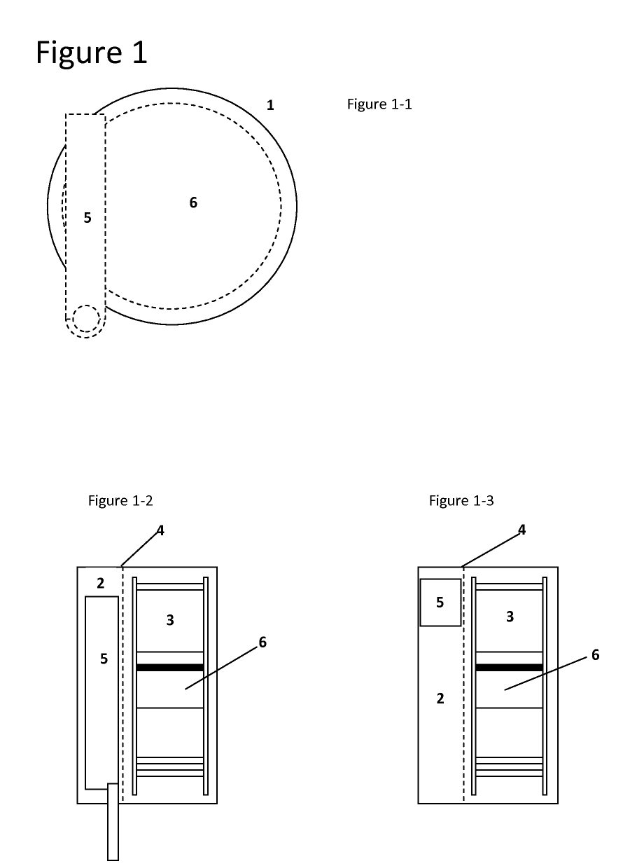

The apparatus claimed herein is comprised of a round satchel 1 partitioned into two compartments 2, 3 separated by a fabric partition 4 as shown in FIG. 1. One compartment 2 contains controlled descent device 5, and a second compartment 3 contains reel 6 upon which safety strap 15 is spooled. Satchel 1 is canvas or nylon in the preferred embodiment, but can be any appropriate material. In the preferred embodiment, the diameter of reel 6 is such that 40 feet of safety strap can be wound on the reel, although a greater length can be accommodated if the size of the reel is increased commensurately. However, 40 feet was chosen for the preferred embodiment because the majority of tree stands are used no higher than 40 feet. It is important that the reel be sized exactly, as friction between the reel's screw channels 7 and safety strap 15 holds the safety strap on the reel snugly, yet allows the hunter to release and unwind the safety strap from the reel after a fall, as will be explained below.

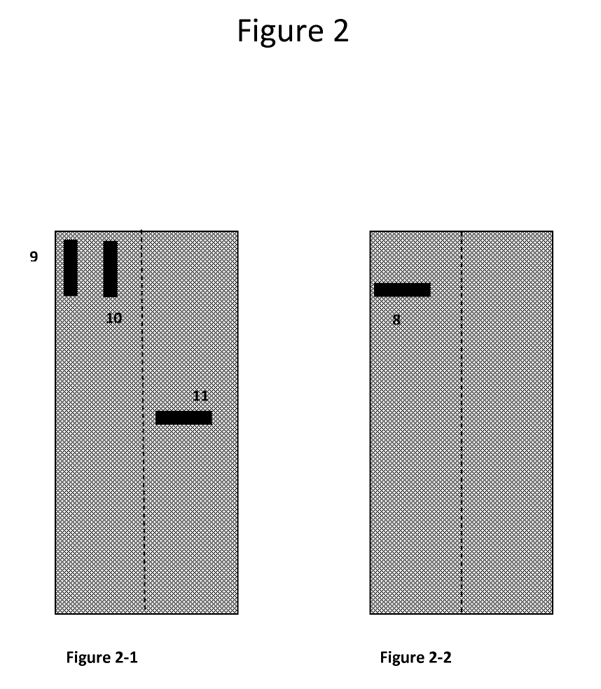

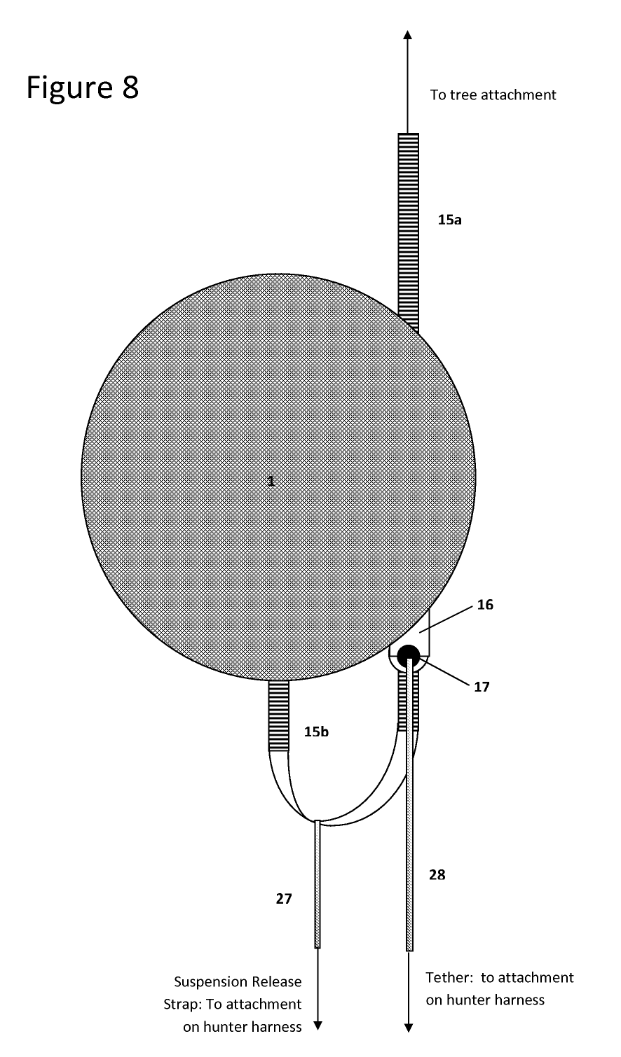

Referring now to FIG. 2-2, the top of satchel 1 has a single hole 8 allowing the portion of the safety strap that will be attached to the tree to exit the satchel. Holes 9, 10, and 11 are in the bottom side of satchel 1, as shown in FIG. 2-1. Holes 9 and 10 allow eye 17 of controlled descent device 5 and safety strap 15b to pass out of compartment 2, respectively. Hole 11 in the bottom of satchel 1 permits the second end of safety strap 15b to pass into compartment 3, where it is wound around reel 6. In this paragraph, “top” and “bottom” refers to the satchel's orientation when the apparatus is in use, as shown in FIG. 8.

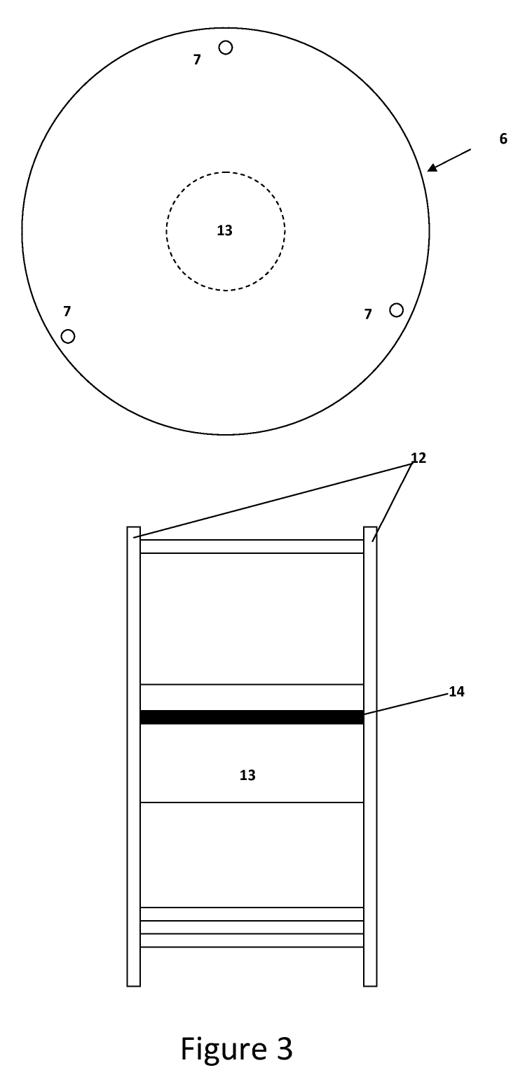

Reel 6 is made of 2 circular aluminum plates 12 with a freely rotating core 13 with a slot 14 into which the end of the second end of safety strap 15b is inserted, as shown in FIG. 3. As described above, the diameter of the plates 12 is dependent on the length of the safety strap to be wound around the reel. Safety strap 15b is then wound onto the core until it is held snugly by the three screw channels 7 spaced 120 approximately degrees apart around the perimeter of the reel. The safety strap is wound onto the reel so that the friction between screw channels 7 and the safety strap prevents the safety strap from unwinding from the reel. However, when the safety strap is pulled firmly the safety strap will come loose and begin to unwind from the reel freely. That is, the core of the reel is designed so that continuing to pull on the safety strap once it has broken loose will cause the safety strap to unwind rapidly from the reel under its own weight.

The weight-bearing end of safety strap 15a is attached securely to the tree. This tensioned end passes through hole 8 in the top of the satchel and into controlled descent device 5.

Safety strap 15 in the preferred embodiment is made of nylon fiber and is 1″ wide. Although seatbelt-type webbing was originally considered, webbing containing ridges oriented perpendicular to the direction of strap travel was found to be most effective in allowing the cam grip to engage. Although the safety strap can be wider than 1″, it was found that 1″ wide nylon weave was sufficient to support loads of up to 400 lbs.

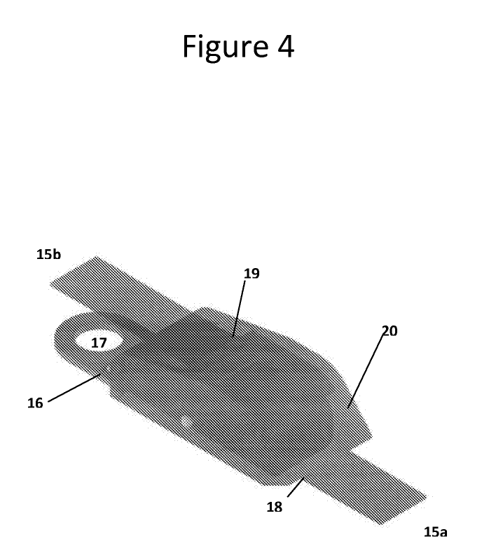

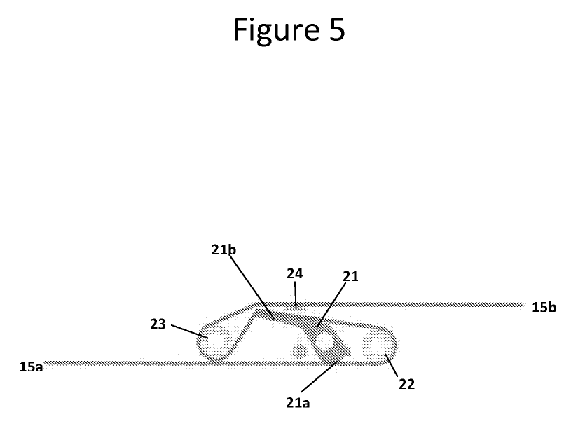

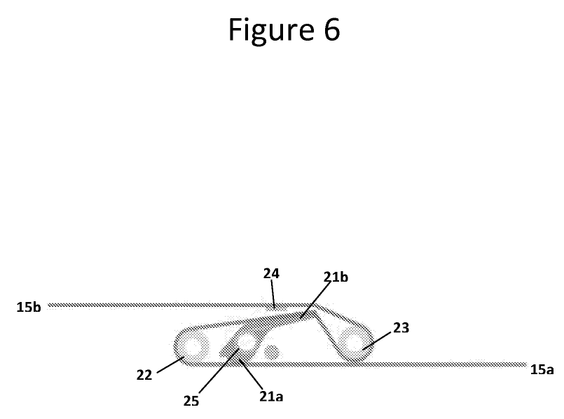

A first portion of safety strap 15a is the weight-bearing portion of the safety strap. It is attached to the tree (or onto another strap fastened to the tree) and passes into controlled descent device 5 through hole 8 in the top of satchel 1. It then passes into the controlled descent device through hole 18 in cover 20 as shown in FIG. 4. It is engaged by braking surface 21a of cam brake 21, as shown in FIGS. 5 and 6.

Referring again to FIGS. 5 and 6, a second portion of the safety strap 15b, will be referred to as the releasing end or non-tensioned end. It begins at cam brake 21 and passes around roller 22, over cam lever 21b, around roller 23 and over guide 24 before passing out of the controlled descent device 5 through hole 19 in cover 20 as shown in FIGS. 4 and 6. The releasing end 15b then passes out of compartment 2 through hole 10 and into compartment 3 through hole 8, where its excess length is wound around reel 6.

Controlled descent device 5 is comprised of several components. Base plate 16 shown in FIG. 4 is made of mild steel approximately 0.120″ in thickness in the preferred embodiment. Baseplate 16 features an eye 17, which serves as the attachment point for tether 28 that is attached to the hunter's safety harness. In the preferred embodiment, eye 17 is coated with Line-X® or other comparable protective coating to prevent metal-on-metal contact. Nested within the baseplate are rollers 22 and 23, cam brake 21, guide 24, and torsion spring 25. The rollers 22 and 23, cam brake 21, and torsion spring 25 are held in position using pins and rivets to baseplate 16. In the preferred embodiment, these pins and rivets are zinc, although other suitable materials known to the art may be used.

FIGS. 5 and 6 show the internal components of controlled descent device 5 with base plate 16, cover 20, pins, and rivets removed for clarity. Spring-tensioned cam brake 21 is positioned between rollers 22 and 23. Cam brake 21 has a braking surface 21a and a lever 21b. Braking surface 21a engages the first portion of safety strap 15a so that when the safety strap is travelling freely—as during a fall—braking surface 21a will engage the safety strap by pinching the safety strap between it and the baseplate. Braking surface 21a may be textured in any manner known to the art to maximize gripping and braking efficiency while minimizing damage to the nylon strap; in the preferred embodiment, a “waffle iron” type pattern is used for braking surface 21a.

Referring now to FIG. 6, torsional spring 25 tensions cam brake 21 so that the braking surface 21a rests lightly against the safety strap 15a and engages when there is any sudden travel in the safety strap (as during a fall). In the preferred embodiment, cam 21 is made of zinc alloy, although any suitable material known to the art may be used.

Continuing to refer to FIGS. 5 and 6, rollers 22 and 23 are cylindrical and made of Delrin® plastic with a zinc alloy pin holding the rollers in position on the baseplate. In the preferred embodiment, the Delrin® rollers have a ¼″ inside diameter and a ½″ outside diameter and extend across the entire width of the baseplate.

This arrangement of the components within controlled descent device shown in FIGS. 4 and 5 allows a fallen hunter to controllably lower himself to the ground. Tensioned end of safety strap 15a passes into the controlled descent device through hole 18 in cover 20 and is engaged by cam braking surface 21, which grips the textured surface of safety strap 15a and prevents its travel through the controlled descent device. Cam brake 21 is spring-loaded and designed so that the more force is applied to the tensioned end of safety strap 15a, the tighter braking surface 21a will grip. However, when the user desires to release the brake, the configuration of rollers 22 and 23 allows the user to release the brake without applying pressure directly to the cam lever 21b. This is accomplished when the user pulls on the releasing end of safety strap 15b. Roller 23 redirects the tension force applied by the user so that the strap causes cam lever 21b to move downward, thereby causing braking surface 21a to disengage and allow safety strap 15 to travel freely through the controlled descent device. If the user subsequently releases the tension on non-weight-bearing portion of safety strap 15b, torsional spring 25 causes the braking surface 21a to reengage, stopping travel of the safety strap through the controlled descent device.

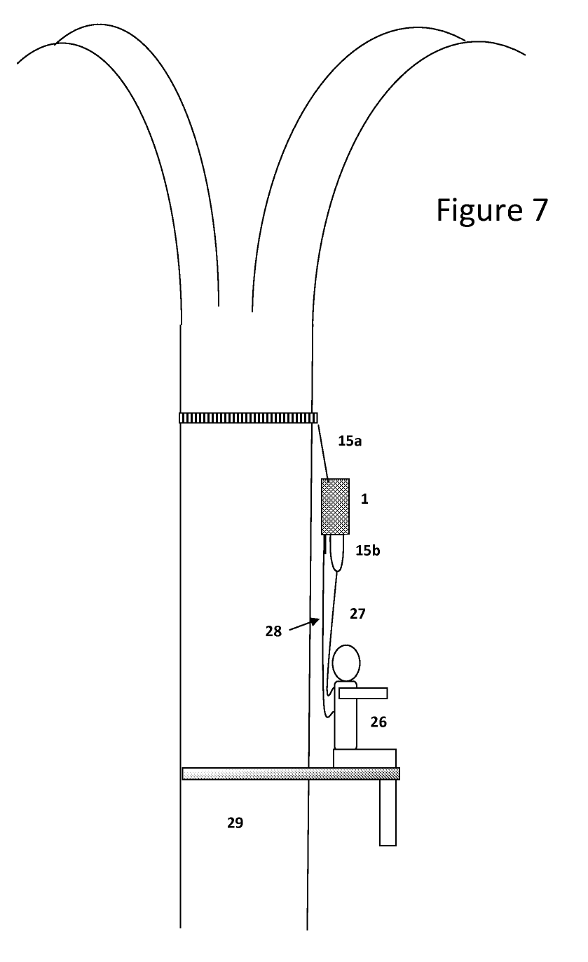

Having described the configuration of its components, use of the apparatus will now be described. Referring to FIGS. 7 and 8, weight bearing end of safety strap 15a is attached to the tree. In the preferred embodiment, the free end of safety strap 15a is attached to a carabiner, which is then attached to a line or strap that is fastened or anchored securely to the trunk of tree 29. Tether 28 is typically 24″-36″ long. One end of tether 28 is attached to eye 17 and the other end is attached to the hunter's safety harness. The tether should be adjusted so that its length is minimized. With the hunter 26 in the normal sitting position shown in FIG. 7, the apparatus should be above the hunter's head, with little or no slack in the tether.

A first end of release strap 27 is attached to the loop of safety strap 15b that is outside the satchel, while the second end is attached to tether 28 where the hunter can easily reach it. The release strap is used in the event of a fall and is required because once a hunter has fallen, the apparatus will typically be out of reach of the hunter. When the hunter has freed himself from any entanglements and is ready to begin a controlled descent, the first step is to pull release strap 27, which frees releasing end of safety strap 15b and cause it to unspool from reel 6. As mentioned above, a firm pull of several pounds force should be sufficient to break safety strap 15b free from the reel. After only a small amount of safety strap 15b is pulled free using release strap 27, the safety strap's own weight will cause the entire length of the safety strap 15b on the reel to quickly unwind. The releasing end of safety strap 15b that is inserted into slot 14 should come free once the safety strap has unwound from the reel, allowing the length that was wound around the reel to fall toward the ground. Once the releasing end of safety strap 15b has been released and allowed to unwind to the ground, the hunter gathers up the entire length of safety strap 15b and arranges it so that it runs over one shoulder front of his body, and through one or more belt loops at the waist of his full body harness. At this point, it is important to note that the hunter is being suspended by tether 28.

When the hunter is ready to lower himself to the ground, he reaches above his head with one hand and grabs the releasing end of safety strap 15b. Simultaneously, his other hand should grip the portion of the safety strap near his waist. The hunter then releases the braking surface 21a of controlled descent device 5 by firmly pulling safety strap 15b with the hand above his head. As described above, this tension on safety strap 15b actuates the cam lever 21b causing braking surface 21a to disengage and allow safety strap 15 to travel through the controlled descent device. The controlled descent device and the satchel then trolley's along the safety strap until the hunter has reached the ground. The hunter controls his rate of descent by squeezing on the safety strap with the hand near his waist belt loops. The tighter the hunter squeezes, the slower the rate of descent. Descent can also be arrested entirely by releasing tension on safety strap 15b with the overhead hand and allowing cam brake 21 to re-engage.

While the present invention has been disclosed in terms of a preferred embodiment and variations thereof, the invention is not limited to the specific embodiments described herein. The scope of the invention is limited only by the appended claims and their legal equivalents and may encompass additions, deletions and modifications to the disclosed embodiments and its variations.

What is claimed is:

1. A fall arresting apparatus, comprising:
A manually-releasable controlled descent device, further comprising
A cam brake; and
Rollers;
A reel;
A safety strap comprising a first end and a second end passing through said controlled descent device; said first end attached to a fixed support structure and said second end releasably attached to said reel; and
A satchel;
Wherein said rollers are arranged on opposite sides of said cam brake allowing said second end of said safety strap to release said cam brake when tension is applied to said second end of said safety strap.

2. The fall arresting apparatus of claim 1 wherein said cam brake is comprised of a braking surface and a cam lever capable of disengaging said braking surface.

3. The fall arresting apparatus of claim 2 wherein said rollers redirect tension applied to the second end of said safety strap, said tension actuating cam lever arm and causing said braking surface to disengage.

4. The fall arresting apparatus of claim 1, wherein said fixed support structure is a tree.

5. The fall arresting apparatus of claim 1, wherein said controlled descent device and reel are contained within a satchel.

6. A manually-releasable controlled descent device, comprising
A cam brake;
A safety strap comprising a weight bearing portion and a non-weight bearing portion; and
Means for redirecting said safety strap
Wherein said means for redirecting permits said safety strap to release said cam brake when tension is applied to the non-weight bearing portion.
